(19) United States
(12) Patent Application Publication
(10) Pub. No.: US 2017/0206544 A1
(43) Pub. Date: Jul. 20, 2017

(54) PREPAID ASSISTANCE FOR THE LESS FORTUNATE

(71) Applicant: Adam Carity, Queen Creek, AZ (US)

(72) Inventor: Adam Carity, Queen Creek, AZ (US)

(21) Appl. No.: 15/478,976

(22) Filed: Apr. 4, 2017

(51) Int. Cl. G06Q 30/02; G06Q 10/08; G06Q 30/06

(52) U.S. Cl. CPC G06Q 30/0225; G06Q 30/0635; G06Q 10/083

(57) ABSTRACT

The various embodiments herein disclose a method of assisting a monetarily less fortunate end user through prepaid item purchasing and delivering. The method comprises creating a user account over an online platform with personal and financial details of the user. The user selects a item through the online platform and complete a payment for the selected item. The purchased item is inventoried by and tracked by an item number, order ID, voucher ID, claim number, and a tracking number. The user also has an option to select a distributor for the delivery of the purchased item. The claim number is associated with a created voucher and the voucher details corresponding to the claim number are also saved in the central database. The selected distributor for the purchased item screens a recipient on the basis of necessity of the recipient and then allocates the voucher to the recipient. The recipient has to claim the item against the claim number from the distributor.

### BACKGROUND

1. Technical Field of Invention

The embodiments herein generally relate to an e-commerce and supply management method and particularly relates to a method for buying and distributing a plurality of items and services to a preselected group of less fortunate end-users. The embodiments herein more particularly relate to a browser-based method through which a registered user prepays for a plurality of items that less fortunate individuals and/or families can claim with a voucher which is obtained from a distributor.

2. Description of Related Art

E-commerce (electronic commerce or EC) is the buying and selling of goods and services, or the transmitting of funds or data, over an electronic network, primarily the internet. These business transactions occur either as business-to-business, business-to-consumer, consumer-to-consumer or consumer-to-business. Generally, e-commerce transactions are done for purchasing for self, family or friends.

However, major e-commerce platforms fail to provide a transaction and distribution of items to an individual, a group of individuals, a family or a community who are monetarily not steady for supporting daily or basic needs of livelihood.

In the view of foregoing, there is a need for a method to allow a buyer for purchasing a selected item (e.g. goods, services, or items) from an online platform and purchase it for an individual, a group of individuals, a family or a community with insufficient earning. Also, there is a need for a method to allow an individual, a group of individuals, a family or a community with insufficient earning to receive a purchased item through a predetermined distribution channel. Furthermore, there is a need for a method to track, inventory, and assign the purchased items specifically to an end recipient. Additionally, there is a need for a method of a recipient verification to ensure the recipient claiming the item purchased for them is in fact the person the item was issued to.

The above mentioned shortcomings, disadvantages and problems are addressed herein, as detailed below.

### OBJECT OF THE INVENTION

The primary object of the embodiments herein is to provide a method to allow a buyer for purchasing a selected item from an online platform and purchase purchase it for an individual, a group of individuals, a family or a community with insufficient earning.

Another object of the embodiments herein is to provide a method to allow an individual, a group of individuals, a family or a community with insufficient earning to receive a purchased item through a predetermined distribution channel.

Yet another object of the present invention is to provide a method to track, inventory, and assign the purchased items specifically to an end recipient.

Yet another object of the present invention is to provide a method of a recipient verification to ensure the recipient claiming the item purchased for them is in fact the person the item was issued to.

These and other objects and advantages of the embodiments herein will become readily apparent from the following detailed description taken in conjunction with the accompanied drawings.

### SUMMARY OF THE INVENTION

The various embodiments herein disclose a method of assisting a monetarily less fortunate end recipient through prepaid item purchasing and delivering. The method comprises creating a user account over an online platform with personal and financial details of the user. The user selects an item through the online platform and completes a payment for the selected item. The user also has an option of attaching a personal message for the end recipient. The purchased item is inventoried by an item number, an order number, a claim number, a tracking number, and a voucher identification number. The claim number and tracking number is sent to a buyer, a seller, a distributor and a recipient collectively named as applicable parties over a computing device as well as stored in a central database. The item number, claim number, tracking number and voucher identification number is eventually associated with a voucher and the voucher details corresponding to the item number, the claim number, the tracking number and the voucher identification number are also saved in the central database. The selected distributor for the purchased item screens a recipient on the basis of necessity of the recipient and then allocates a voucher (which represents a prepaid item/service) to the recipient. The distributor creates a profile for a recipient and captures a photograph of the recipient as part of the profile. The recipient profile information is associated with the claim number assigned to the voucher received by the recipient. The recipient has to claim the item or service against the claim number from the distributor. The recipient profile information is verified at a time of claim of an item/service. The recipient information is stored in the central database and is accessible by the applicable parties.

According to an embodiment herein, the claim number is non-transferrable and lapsable in nature.

According to an embodiment herein, the user select a quantity of the item and frequency of purchase.

According to an embodiment herein, the frequency of purchase comprises one time purchase, weekly purchase, monthly purchase and yearly purchase.

According to an embodiment herein, the user selects the item on an online platform over a computing device comprising a laptop, a personal computer, a mobile device and a, Smartphone, or “in-store” kiosk.

According to an embodiment herein, the user selects the item on an online platform over an in-store tablet provided to the supplier.

According to an embodiment herein, the in-store tablet shows total number of “items” purchased for a location selected by the user in real time.

According to an embodiment herein, the user follows a process based on user selected filtering during a purchase of an item comprising the steps of:
a) Selecting a supplier;
b) Appearing of the supplier's profile page;
c) Populating a list of participating locations on the profile page;
   i) Populating a list of items or meals on the profile page in case of only one participating location;
   ii) Selecting the supplier's location, wherein on selection of supplier's location, a list of items or meals populates the profile page;
d) Purchasing one or more items from populated list.

According to an embodiment herein, the method implements a central server for creating a unique identification numbers (ID) for tracking of items during a supply chain. The online platform runs on the central server.

According to an embodiment herein, the central server generates an item ID for each item uploaded by the supplier on the online platform. The item ID is assigned with an order ID, a claim number and a tracking number after the item with said item ID is ordered by the user.

According to an embodiment herein, the central server generates a voucher ID for a purchased item after allocating to a distributor. The voucher ID contains details of said distributor and assists in managing inventory corresponding to said item.

According to one embodiment herein, when the distributor issues an item to the recipient, the central server assigns the recipient's profile information (photograph of the recipient is a mandatory requirement) to the order ID, the claim number, the tracking number, and the voucher ID number. The central server then creates a printable and a digital voucher and embeds the item and the supplier information along with the recipient's profile information in a scan-able code to be printed on the voucher. Alternatively, the item and the supplier information gets embedded in a printable voucher such as a credit card or encoded in a digital voucher.

These and other aspects of the embodiments herein will be better appreciated and understood when considered in conjunction with the following description and the accompanied drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIG. 1 illustrates a flowchart for a method of a prepaid assistance in purchaseing and delivering a selected item to a less fortunate, according to one embodiment of the present invention.

### DETAILED DESCRIPTION OF THE DRAWINGS

In the following detailed description, a reference is made to the accompanied drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

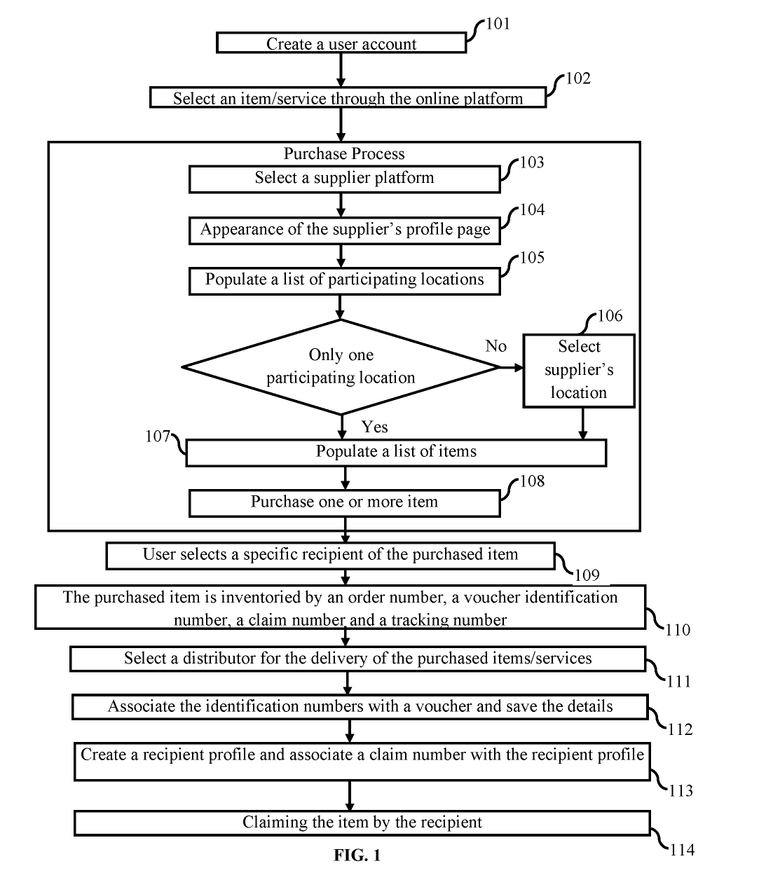

FIG. 1 illustrates a flowchart for a method of a prepaid assistance in purchasing and delivering a selected item to a less fortunate, according to one embodiment of the present invention. With respect to FIG. 1, the method comprises creating a user account over an online platform with personal and financial details of the user (101). The user selects a item through the online platform (102) and completes a payment for the selected item. The user follows a process during a purchase of an item comprising the steps of:
a) Selecting a supplier (103);
b) Appearing of the supplier's profile page (104);
c) Populating a list of participating locations on the profile page (105);
   i) Populating a list of items or meals on the profile page in case of only one participating location (106);
   ii) Selecting the supplier's location, wherein on selection of supplier's location, a list of items or meals populates the profile page (107);
d) Purchasing one or more items from populated list (108).

The user has the option to select a specific recipient of the purchased item (109) after which the purchased item is inventoried by an order number, a voucher identification number, a claim number and a tracking number (110). The order number, the voucher identification number, the claim number and the tracking number is sent over a computing device to all applicable parties involved. The user can also select a distributor for the delivery of the purchased item, or a central server assigns a distributor automatically (111). The order number, voucher identification number, claim number and the tracking number is then stored in a central database as well as sent to the selected applicable parties. The order number, the voucher identification number, the claim number and the tracking number is associated with a voucher and the voucher details corresponding to the claim number are also saved in the central database (112). The selected distributor for the purchased item screens a recipient on the basis of necessity of the recipient and then allocates the voucher to the recipient. The distributor creates a user profile for each recipient and captures a photograph of the recipient and associates their profile with the claim number received by the recipient (113). The recipient has to claim the item against the claim number from the distributor (114).

According to an embodiment herein, the claim number is non-transferrable and lapsable in nature.

According to an embodiment herein, the user select a quantity of the item and frequency of purchase.

According to an embodiment herein, the frequency of purchase comprises one time purchase, weekly purchase, monthly purchase and yearly purchase.

According to an embodiment herein, the user selects the item on an online platform over a computing device comprising a laptop, a personal computer, a mobile device, and a Smartphone, or “in-store” kiosk.

According to an embodiment herein, the user selects the item on an online platform over an in-store tablet provided to the supplier.

According to an embodiment herein, the in-store tablet shows total number of “items” purchased for a location selected by the user in real time.

According to one embodiment herein, a browser based online platform or a mobile app or an in-store platform is provide through which the users can prepay for items like food, retail, professional services, shelter, sleeping bags, clothing, hotel room, temporary housing, etc. for one or more less fortunate people referred as recipients here. The recipients can claim the prepaid items and services with a voucher (which can only be obtained from a distributor) at a later time/date but only after passing a verification process implemented by us or our participating distributors.

Further, the method provides a courier/delivery service for a participating supplier who wants to list their items or services but doesn't want recipients claiming items at their place of business. The prepaid items are preferably get picked up and claimed somewhere other than their place of business of the supplier (like at a distributor's location).

The prepaid items/services purchased are inventoried by an item number, order number, claim number, voucher identification number and tracked with a tracking number. The items purchased (including revenue generated), item number, order number, claim number, voucher identification number, the tracking number, an item's progress, distributor information, recipient information, and other analytical data, are all organized and kept logged in our platform's database and may be viewed in one of our system's applicable user dashboards.

According to one embodiment herein, a dashboard is provided on the online platform having a plurality of customized information related to a supplier, a distributor, or a member (gifter). The dashboards are secure and accessible through a user name and password (or thumb ID). The dashboard has administrators and users. The administrators have full access whereas the users have restricted access to an information set by the administrator.

### Involved Parties

An Owner
A Gifter—People who purchase meals/item on our website, mobile app, or in-store platform
A Member—A Gifter who's created a profile on our platform
A Supplier—Organization providing and selling the items/meals on the website, mobile app, or in-store platform.
A Distributor—Organization (homeless shelters, food banks, school, and other similar organizations) distributing vouchers to verified recipients for the items users purchased through our platform.
Recipient—Person or group receiving the “item voucher” which will be used to claim an item(s) purchased for them.
Merchant—Organization handling the transaction made on our website, mobile app, or in-store platform

### Purchase Process for the Gifter

A gifter can create a profile and become a “member” by following the steps described herein:
a) Gifters come to online platform/mobile app and select a participating supplier from a list of logos/names on the home page.
b) Once a supplier is selected a supplier's profile page comes up and populates a list of participating locations (if they have more than one). If there's only one location, the item/meal options will populate the page.
c) When there are multiple locations a gifter can select a supplier location which when selected populates item options for a gifter to choose from specific to the location selected.
d) Gifters make a selection from the options provided then select a quantity and whether it's a one time purchase, weekly purchase, monthly purchase, or yearly purchase.
e) After selections are made the gifter then checks out and makes the purchase.

People making the purchase and those receiving the items purchased will be able to communicate with each other (if they choose to) through email or through our platform's dashboard. If those receiving the gift do not have a mobile device or computer they'll be able to participate in this communication at a distributor's location via our browser-based platform.

### In-store Process for the Gifter

a) Gifters come to the participating supplier's location and select a gift option from supplier's “in-store” profile page, which is set up on a (P.O.S style) kiosk tablet we provide the supplier. This tablet is restricted strictly to the supplier's “in-store” front end profile which has the same item options as the website/mobile app profile and is updated in real time across all applicable platforms/profiles. Once a purchase is made the backend process (payment handling, inventory, tracking, and claim number creation) is also the same as the other platforms.
b) Payments are made directly and securely through the tablet (swipe/chip/apple pay reader options available). The backend process (claim and tracking numbers, etc.) and merchant process remains the same as the other platforms (mobile app, browser based, etc).
c) An area of the tablet will display the all time total number of “items” purchased for that particular location in real time.
d) Option for a separate larger “tally screen” can be added which will also show the total number of items gifted for that location in real time.
e) If they are a “member” they can log into their profile to complete the in-store transaction so that the member benefits apply to that particular purchase.

An option to integrate the additional purchase of a prepaid item in-store at the point of sale will be available to the supplier. This option and process will link directly to our system and update accordingly across all platforms.

### Backend Process After the Purchase on the Website

a) Immediately after a purchase is made (on any platform/device) funds received from the purchase are distributed according to the agreed upon terms by the Supplier and an owner of the online platform. (e.g. a percent to the Merchant, a percent to the Supplier, and a percent to the owner).
b) Immediately after a purchase is complete, tracking number(s) and claim number(s) is generated. Both tracking and claim numbers are assigned/linked specifically to the item(s) purchased. If there are multiple items, each item gets its own tracking and claim number.
c) Tracking numbers are sent to a gifter (and stored in a member's dashboard if they've created a profile/account) with their receipt via email immediately after the purchase is complete. Tracking Numbers are used to “track” the progress of the claim number. Tracking allows a gifter to know when the item(s) they've purchased have been assigned to a distributor and when a distributor has issued the “item voucher” to a verified recipient.
d) Claim numbers (once generated) are inventoried in online platform as pending until issued by an administrator to a participating distributor, which at that point are labelled assigned. Once a claim number has been assigned the system is updated and triggers an email to be sent in real time to the supplier and gifter (members only) informing them of the distributor's details. The distributors then issue claim numbers to recipients at which point the system is updated again and triggers an email in real time to the supplier and gifter (members only) informing them who the claim number has been issued to (including the recipient's photo and “story”—if recipient elects to share that information).

### Distributor's Role

Screen the recipients and issue claim numbers to recipients—screening includes making certain the recipient is actually in need and will follow basic criteria for claiming their items at a participating supplier's location. The distributors also create recipient profiles in our system and ensure photos of recipients are on file which photos will automatically be linked to the claim number. After the distributor's dashboard is open they'd select a claim number from their incoming inventory list which then prompts them to select a recipient from their active recipient profiles. A recipient's profile info gets linked to a claim number.

### Supplier's Role

Provide items to be purchased—make sure claim numbers (included on/linked to the voucher as a number or scannable code) match recipient's photo/id when recipient attempts to claim their item.

### Tracking Number's Function

Tracks when a recipient has claimed an item. Gifters can enter a tracking number in a search bar (on the online platform) to track whether their gift has been claimed. For members, tracking is automatically visible and updated in the dashboard of their member profile. The members will be emailed of each status change, whereas non-member gifters have to go to the website or app to check the status.

### Claim Number's Function

Gets assigned/attached to the items purchased and the person who purchased the items at the time of purchase (digital representation of the item(s)/meal(s)). The claim numbers are what get entered into the suppliers in-store tablet to verify the recipient is the one the voucher was assigned to. The claim numbers are invalid after one use. The claim numbers are issued electronically to the distributors (transferred to their dashboard) by us based on supply, demand, or distributor request using the distributor item request function of their dashboard. The claim numbers are then assigned digitally to recipients by to distributors. Once an item is assigned to a recipient the claim number gets assigned to the voucher ID number and the recipient's profile. The claim number also gets associated with the scannable code which is generated when a voucher is created. The claim number will then call the assigned recipient's profile information when the item the voucher represents is being claimed.

The claim numbers are non-transferable. The issued claim numbers will also have an expiration date where once expired the recipient will no longer be linked to that claim number and the claim number will go back in to the distributor's queue to be reassigned to a recipient.

### Voucher's Function

A voucher is what gets issued to a recipient and what a recipient gives to a supplier to redeem/claim their prepaid item(s). The claim numbers (and other data) are linked to vouchers and vouchers are given to recipients and recipients give vouchers to suppliers. The vouchers are in the form of an event ticket with a corresponding stub as well as a gift certificate style, hand written option. As funding permits, our system will accommodate credit card like vouchers with radio frequency identification (RFID), reloadable technology, and/or near field communication (NFC). Suppliers get the claim number they need for verification from the voucher. The claim number can be written out or also in the form of scan-able code/data (e.g. Bar/QR/RFID/NFC etc.). This process is all done on the suppliers in-store processing tablet we provide them.

### Functional Aspect of Supplier's In-Store Processing Tablet

Provides a screen with the supplier's logo and a place to enter a claim number or scan any type of code/data as mentioned previously. When an incorrect claim number is entered/scanned a notification that the claim number is incorrect will show and the claim can then be denied which will then render the claim number invalid. All involved parties will be notified of a denial in real time. If the claim number is correct a photo of the recipient will show along with the relative item(s) to be claimed. If the photo on the screen matches the recipient claiming the item, an option to complete (approve the claim) the transaction will appear. If the items are “fast food” or “restaurant” related no further action will be needed and the transaction will be completed. If the items are “packaged” (like from a grocery store or sporting goods store etc) a space for the bar code of the item(s) will be available to scan/ enter the dashboard for tracking and inventorying purposes on the supplier's side of things. All involved parties are then notified of the successful transaction in real time.

### Member Privileges

a) Automatic updates informing the member of their purchase's status.
b) An accounting (dashboard stats) of their purchases and those who were the recipient of their purchase.
c) Possible rewards and badges earned based on total purchases.
d) Email updates on new distributors/locations, suppliers/locations, items/meal options/etc, email updates on owner news.
e) Able to receive messages from recipients who want to personally thank their gifter.
f) Can earn badges based on the amount of items purchased and can be featured on our home page as a “top gifter” if they elect to be featured.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A method of assisting a monetarily less fortunate end user through prepaid item purchasing and delivering, the method comprises, but is not limited to, the steps of:
creating a user account over an online platform with personal and financial details of the user;
selecting a item through the online platform and completing a payment for the selected item;
inventorying the purchased item by an order number, a claim number, a voucher identification number, and a tracking number, wherein the order number, the claim number, the voucher identification number and the tracking number is sent over a computing device of the user;
selecting a distributor for the delivery of the purchased item by the user;
sending the claim number to the selected distributor;
associating a voucher with the claim number, wherein the voucher details corresponding to the claim number are saved in a central database;
screening of a recipient by the selected distributor for the purchased item and allocating the voucher to the recipient, wherein the distributor captures a photograph of the recipient and associate the captured photograph with the claim number received by the recipient;
wherein, the recipient has to claim the item against the claim number from the distributor.

2. The method as claimed in claim 1, wherein the claim number is non-transferrable and lapsable in nature.

3. The method as claimed in claim 1, wherein the user select a quantity of the item and frequency of purchase.

4. The method as claimed in claim 3, wherein the frequency of purchase comprises one time purchase, weekly purchase, monthly purchase and yearly purchase.

5. The method as claimed in claim 1, wherein the user selects the item on an online platform over a computing device comprising a laptop, a personal computer, a mobile device, a Smartphone, or in-store kiosk.

6. The method as claimed in claim 1, wherein the user selects the item on an online platform over an in-store tablet provided to the supplier.

7. The method as claimed in claim 6, wherein the in-store tablet shows total number of “items” purchased for a location selected by the user in real time.

8. The method as claimed in claim 1, wherein the user follows a process during a purchase of a item comprising the steps of:
a) Selecting a supplier;
b) Appearing of the supplier's profile page;
c) Populating a list of participating locations on the profile page;
i) Populating a list of items or services on the profile page in case of only one participating location;
ii) Selecting the supplier's location, wherein on selection of supplier's location, a list of items or services populates the profile page;
d) Purchasing one or more items from populated list.

9. The method as claimed in claim 1 implements a central server for creating a unique identification numbers (ID) for tracking of items during a supply chain.

10. The method as claimed in claim 9, wherein the central server generates an item ID for each item uploaded by the supplier on the online platform, wherein the item ID is assigned with an order ID, a claim number and a tracking number after the item with said item ID is ordered by the user.

11. The method as claimed in claim 9, wherein the central server generates a voucher ID for a purchased item after allocating to a distributor, wherein the voucher ID contains details of said distributor and assist in managing inventory corresponding to said item.
